(19) United States
(12) Patent Application Publication
(10) Pub. No.: US 2005/0015969 A1
(43) Pub. Date: Jan. 27, 2005

(54) Method for producing an electric machine subassembly produced according to said method, and electric machine with said subassembly

(76) Inventors: Andreas Grundl, Munchen (DE); Bernhard Hoffmann, Otto-Gassner-Str.3 (DE)

Correspondence Address: KEVIN FARRELL;PIERCE ATWOOD, ONE NEW HAMPSHIRE AVENUE, PORTSMOUTH, NH, 03801, US

(21) Appl. No.: 10/221,816

(22) PCT Filed: Mar. 8, 2001
(86) PCT No.: PCT/EP01/02624

(30) Foreign Application Priority Data
Mar. 17, 2000 (DE) 10013123.9

(51) Int. Cl. H02K 15/00

(52) U.S. Cl. 29/596; 29/598; 29/732

(57) ABSTRACT

The invention relates to a method for the manufacture of an assembly of an electric machine with the steps of: manufacturing at least one portion of a coil of a rotor or stator of an electric machine; positioning the at least one portion of the coil in a casting mould, whose cavity shape reproduces at least a portion of the assembly; filling the casting mould with pulverised soft iron particles with a thermoplastic synthetic coating; heat treatment of the filled casting mould until the synthetic coating of the soft iron particles softens; allowing the filled casting mould to cool; and removing the assembly from the casting mould.

### BACKGROUND OF THE INVENTION

The invention relates to a method for the manufacture of an assembly of an electric machine and an assembly which can be manufactured to this method, as well as an electric motor comprising such an assembly.

Definitions

The term “assembly of an electric machine” as used herein is to be understood as covering both a stator of an electric machine and, under certain conditions which will be described later, a rotor. An electric machine in this context is both an electric motor as well as an electric generator, regardless of whether the electric machine is designed as a rotary machine or, for example, as a linear motor.

State of the Art

In the state of the art it is known to build the magnetically conductive parts of an electric machine (in particular of an alternating current machine) of laminations because of the otherwise occurring eddy currents. For the laminated cores, typically single or double-sided insulated sheet panels of a thickness between 0.35 mm and 1.5 mm of dynamo sheet metal (hot rolled electric-quality sheet) are cut to correspondingly shaped strips. From these strips stator and rotor laminations with respective recesses are punched, whereby it is aimed at producing as little scrap as possible. The stator and rotor laminations manufactured in this manner are stacked upon each other and under pressure united to laminated cores in which the recesses of the individual laminations form grooves for the stator or rotor windings to be subsequently installed.

These stator or rotor windings are preassembled and insulated preformed coils which are inserted into the open grooves. In the case of closed grooves the winding wires must be threaded in from the face of the laminated cores so that a corresponding coil is created.

The above described approach has been developed in several detail aspects. In the manufacture of electric machines it has, in principle, been the proven and employed method for many decades and has not seen any fundamental changes. The above explanation, however, also shows that the manufacture is very expensive, that punching scrap is produced in the punching operation of the laminations, and that the installation operation of the windings or winding wires, respectively, into the groove is very time consuming. Moreover, so-called winding overhangs (portions of the windings which protrude beyond the face of the laminated cores) are inevitable, which do not contribute effectively to the performance of the electric machine.

A development originating from a completely different field consists of providing finely pulverised soft iron particles with a thermoplastic coating of a synthetic material. Particularly well suited for this purpose is an iron powder where the iron particles with a diameter of approx. 20-150 μm have a coating of polyethylene of approx. 2-10 μm. Such a powder is, for example, described in SAE Technical Paper Series, “P/M Cores for Pulsed DC Ignition Systems”, David E. Gay, International Congress & Exposition, Detroit, Mich., Feb. 24-27, 1997. The materials described therein are suited for the implementation of the invention. It is, however, also possible to use corresponding materials with similar properties from other manufacturers for the inventive method.

The inventors have found that such a material, in a surprising manner, is excellently suited to revolutionise the concept of the manufacturing process for electric machines or their assemblies, respectively, with the potential to manufacture electric machines, whose electric properties, in some cases, are even better than those of conventional electric machines which are comparable with respect to size, type of construction, etc.

Problem on Which the Invention is Based

Starting from the initially described approach for the manufacture of an electric machine, the invention is based on the problem to fundamentally simplify this operation in order to render it significantly more economic.

The inventive solution of this object consists in a method for the manufacture of an assembly of an electric machine with the following steps:
manufacturing of at least one portion of a winding of a rotor or stator of an electric machine;
positioning of the at least one portion of the winding in a casting mould, whose cavity shape reproduces at least a portion of the assembly;
filling of the casting mould with pulverised soft iron particles with a thermoplastic synthetic coating;
heat treatment of the filled casting mould until the synthetic coating of the soft iron particles softens;
allowing the filled casting mould to cool; and
removing the assembly from the casting mould.

This completely novel way of manufacturing electric machines or their components, respectively, has a number of significant advantages:

Obviously, the expensive assembly step of placing the winding into the grooves of the laminations is omitted. In addition, assembly and alignment of the laminations relative to each other is no longer necessary. Furthermore, the winding can virtually be completely surrounded by the soft iron particles, so that no winding overhangs develop. In addition, the wires of the winding are not accommodated in preformed grooves. Rather, the soft iron particles adhere directly to the wires of the winding, so that virtually no air gap exists between the wires of the winding and the moulded body of soft iron particles (except the material thickness of the synthetic coating of the soft iron particles).

Advantageous Developments of the Invention

In an embodiment of the inventive method the soft iron particles which have been introduced into the casting mould are mechanically compacted to such an extent before the heat treatment, that air pockets are no longer present within the soft iron particle powder or at the interfaces between the powder and the coil(s). This can be achieved by shaking, vibrating of the casting mould, compressing by means of a male mould, or the like, as well as by combinations of the individual above mentioned methods.

In a further embodiment of the inventive method, a recess is formed in the soft iron particles in the casting mould before or during the heat treatment, into which an electronic circuit (e.g. a control circuit or a sensor assembly) for the electric machine is installed. The ends of the coil(s) may end in this recess so that the electronic circuit can be directly connected with them.

The heat treatment step is performed in such a manner that the insulation of the winding wire (of paint, synthetic material, enamel, or ceramic material) is not damaged. Preferably, the heat treatment is performed at approx. 2500-350° C., until the soft iron particles are surrounded by a uniformly melted synthetic coating, without the iron particles coming into a significant magnetically (or electrically) conductive connection with each other.

In a preferred embodiment of the inventive method, which is particularly suited for the manufacture of a rotor of an asynchronous motor, the coil forming the squirrel-cage rotor is made by casting. Alternatively, the coil can be manufactured by punching recesses from a circular cylindrical tube of aluminium or copper. In both cases, the coil which is manufactured in this manner is subsequently surrounded by the soft iron particles and heat treated.

The invention also relates to an assembly for an electric machine, wherein one coil is at least partially surrounded by iron, with the iron being formed by soft iron particles interconnected by a thermoplastic synthetic coating. The invention finally relates to an electric machine with a stator and/or a rotor which is formed by such an assembly.

In a preferred embodiment of the invention, prior to compacting and heat treating a shaft is installed in the rotor and in the powder, with the shaft comprising an external polygon or projections, in order that the shaft be accommodated secured against rotation and captively after compacting and the heat treatment (and cooling down) in the rotor assembly.

It is understood from the above description that other electric components with inductive components, too, for example reactors or transformers can be manufactured in accordance with this novel method.

1. A method for the manufacture of an assembly of an electric machine with the following steps:
manufacturing of at least one portion of a winding of a rotor or stator of an electric machine;
positioning of the at least one portion of the winding in a casting mould, whose cavity shape reproduces at least a portion of the assembly;
filling of the casting mould with pulverised soft iron particles with a thermoplastic synthetic coating;
heat treatment of the filled casting mould until the synthetic coating of the soft iron particles softens;
allowing the filled casting mould to cool; and
removing the assembly from the casting mould.

2. The method for the manufacture of an assembly of an electric machine according to claim 1, wherein the soft iron particles filled into the casting mould are mechanically compacted prior to the heat treatment.

3. The method for the manufacture of an assembly of an electric machine according to claim 1, wherein a recess is formed in the soft iron particles filled into the casting mould, for the accommodation of an electronic circuit.

4. The method for the manufacture of an assembly of an electric machine according to claim 1, wherein the heat treatment step is performed in such a manner that the insulation of the coil is not damaged.

5. The method for the manufacture of an assembly of an electric machine according to claim 4, wherein the heat treatment is performed at approx. 250°-350° C., until the soft iron particles are surrounded by a uniformly melted synthetic coating, without the iron particles coming into a significant magnetically (or electrically) conductive connection with each other.

6. The method for the manufacture of an assembly of an electric machine according to claim 1, wherein at least one portion of the coil is manufactured from aluminium or copper.

7. The method for the manufacture of an assembly of an electric machine according to claim 1, wherein the coil is manufactured by casting.

8. The method for the manufacture of an assembly of an electric machine according to claim 1, wherein the coil is manufactured by punching recesses from a circular cylindrical tube of aluminium or copper.

9. An assembly for an electric machine, wherein a coil is at least partially surrounded by iron, characterised in that the iron is formed by interconnected soft iron particles with a thermoplastic synthetic coating.

10. An electric machine with a stator and a rotor, characterised in that the stator and/or the rotor is formed by an assembly according to claim 9.
